(19) United States
(12) Patent Application Publication
(10) Pub. No.: US 2002/0117629 A1
(43) Pub. Date: Aug. 29, 2002

(54) Electrospray ion source

(75) Inventors: Susumu Fujimaki, Ibaraki (JP); Jun Tamura, Tokyo (JP)

Correspondence Address: David C. Hanson, WEBB ZIESENHEIM LOGSDON ORKIN & HANSON, P.C., 700 Koppers Building, 436 Seventh Avenue, Pittsburgh, PA, 15219, US

(73) Assignee: JEOL Ltd., Tokyo (JP)

(21) Appl. No.: 10/020,005

(22) Filed: Dec. 12, 2001

(30) Foreign Application Priority Data
Dec. 12, 2000 (JP) 2000-377210
Nov. 5, 2001 (JP) 2001-339617

(51) Int. Cl. H01J 27/00

(52) U.S. Cl. 250/423 R

(57) ABSTRACT

An electrospray ion source is fitted with plural spray nozzles. A nebulization gas is supplied to the nozzles. The supply of the nebulization gas to at least a selected one of the spray nozzles is cut off for a given time. The application of the high voltage to the spray nozzle, for which the supply of the nebulization gas is cut off, is synchronously ceased.

### BACKGROUND OF THE INVENTION

1. Field of the Invention

The present invention relates to an electrospray ion source for use in mass spectrometry and, more particularly, to an electrospray ion source that makes it possible to clearly distinguish ion signals arising from a non-standard substance from ion signals arising from a standard substance.

2. Description of Related Art

The phenomenon that an electrically conductive liquid placed in a strong electric field spontaneously sprays out of the tip of a capillary by the action of the electric field is termed electrospray and has been known for many years. This electrospray was applied to mass analysis of solution samples in the early 1980s and has come to be used widely as electrospray ion sources.

The prior art electrospray ion source is shown in FIG. 1. A solution sample supply source 1 consists of a liquid chromatograph (LC), solution reservoir, or the like. A solution sample, such as an LC mobile phase from the solution sample supply source 1, is sent to a capillary 2 by a pump (not shown) or the like. This capillary 2 is made of a conductor, such as a metal, and has an inside diameter of 100 μm and an outside diameter of 200 to 250 μm. The solution sample sent to the capillary 2 is forced upward through the capillary 2 to its tip by an LC pump or by means of capillarity.

A high voltage of several kilovolts is applied between the capillary 2 and the counter electrode 4 of a mass spectrometer 3 to produce a strong electric field. Because of the action of this electric field, the solution sample in the capillary 2 is electrostatically sprayed into the space between the capillary 2 and the counter electrode 4 under atmospheric pressure. As a result, the sample is dispersed as charged liquid droplets into the atmosphere. At this time, the flow rate of the solution sample is 5 to 10 microliters per minute. The produced charged liquid droplets are charged particles in the form of clusters in which solvent molecules collect around sample molecules. Therefore, if heat is applied to the charged liquid droplets to vaporize off the solvent molecules, ions of only sample molecules are left.

In one method of creating sample ions from charged liquid droplets, nitrogen gas heated to about 70° C. is supplied into the space between the capillary 2 and the counter electrode 4, and charged liquid droplets are electrostatically sprayed into this space, thus vaporizing off the solvent of the liquid droplets. In another method, a sampling orifice 5 formed in the counter electrode 4 of the mass spectrometer 3 is heated to about 80° C. The solvent of the charged liquid droplets is vaporized off by the radiative heat. These methods are known as ion evaporation.

Sample ions created by ion evaporation are taken into the mass spectrometer 3 from the sampling orifice 5 formed in the counter electrode 4. To introduce the sample ions under atmospheric pressure into the mass spectrometer 3 under a vacuum, a differential pumping wall is formed. In particular, a space surrounded by the sampling orifice 5 and a skimmer orifice 6 is evacuated to about 200 Pa by a rotary pump (not shown). A space surrounded by the skimmer orifice 6 and a partition wall 7 is evacuated to approximately 1 Pa by a turbomolecular pump (not shown). The stage that is behind the partition wall 7 is evacuated to about 10⁻³ Pa by the turbomolecular pump. A mass analyzer 8 is placed in this stage.

A ring lens 9 is placed in the low-vacuum space surrounded by the sampling orifice 5 and the skimmer orifice 6 to prevent diffusion of sample ions. Where the sample ions are positive ions, a positive voltage is applied to the lens. Where the sample ions are negative ions, a negative voltage is applied to it. An ion guide 10 is placed in the medium-vacuum space surrounded by the skimmer orifice 6 and the partition wall 7 to guide the sample ions to the mass analyzer 8. An RF voltage is applied to the guide 10.

An electrospray ionization system (not shown in FIG. 1) that has recently appeared on the market uses an improved electrospray ion source. In particular, to cope with high flow rates of samples of 10 to 1000 μL/min, such as LC mobile phases, a spray nozzle capable of passing a nebulization gas is mounted around the capillary 2. High flow rates of samples of more than 10 μL/min that cannot be nebulized if only the action of the electric field is used are completely nebulized by the nebulization gas.

The electrospray ion source is characterized in that it provides a very soft ionization method. That is, when sample molecules are ionized, neither application of heat nor collision of high-energy particles is utilized. Consequently, highly polar biological macromolecules, such as peptides, proteins, and DNAs, can be easily ionized as polyvalent ions such that they are seldom destroyed. Since polyvalent ions are created, if the weight of molecules is more than 10,000, measurements can be performed with a relatively small mass spectrometer.

In the field of this organic mass spectrometry, accurate mass analysis is often performed using an electrospray ion source. The accurate mass analysis means an accurate analysis technique for measuring m/z values at an accuracy of approximately 1 milli-mass-unit (mmu). A standard substance (e.g., polyethylene glycol or polypropylene glycol) of a known mass and an unknown sample to be mass analyzed are simultaneously electrostatically sprayed to ionize them. The signal position of the ion arising from the unknown sample is accurately determined based on the signal position of the ion arising from the standard substance.

To perform an accurate mass analysis, an unknown sample of an unknown mass number and a standard substance of a known mass number must be mass analyzed simultaneously. Accordingly, as shown in FIG. 2(a), in one method, a standard substance is previously mixed into an unknown sample to create a mixture solution 11. This mixture solution 11 is sprayed into an electric field using a pump 12 to ionize the standard substance and the unknown sample together. That is, the standard substance and unknown sample are sprayed simultaneously. Where it is not desired to mix an unknown sample 13 and a standard substance 14, they are mixed in an intermediate location of the fluid passage immediately before the sample solution is electrostatically sprayed into an electric field from the capillary 2, using a T-joint 15, as shown in FIG. 2(b). In a further method, an unknown sample 13 and a standard substance 14 are independently and simultaneously sprayed into an electric field electrostatically, using plural capillaries 2, as shown in FIG. 2(c). Thus, both are ionized.

The accurate mass analysis performed in the prior art electrospray ion source described above is characterized in that a signal of an unknown sample and a signal of a standard substance always overlap each other on the observed mass spectrum, because the unknown sample and the standard substance are sprayed into an electric field at the same time. Therefore, if a signal arising from the unknown sample of interest is superimposed on a signal arising from the standard substance, it has been impossible to discriminate the former signal from the latter signal.

### SUMMARY OF THE INVENTION

In view of the foregoing, it is an object of the present invention to provide an electrospray ion source which makes it possible to distinguish a signal arising from a standard substance from a signal arising from an unknown sample if the former signal overlaps the latter signal where an accurate mass measurement is performed using both known sample and standard substance simultaneously.

This object is achieved by an electrospray ion source in accordance with the teachings of the present invention, the electrospray ion source having plural spray nozzles capable of being supplied with a nebulization gas. A high voltage can be applied to the nozzles, which are used simultaneously. The supply of the nebulization gas to at least a selected one of the nozzles is cut off during a given time.

The invention also provides an electrospray ion source equipped with plural spray nozzles to which a high voltage can be applied. The nozzles are used simultaneously. The application of the high voltage to at least a selected one of the nozzles is ceased for a given time.

Furthermore, the invention provides an electrospray ion source equipped with plural spray nozzles to which a high voltage can be applied. A nebulization gas can be supplied to the spray nozzles. An operation for cutting off the supply of the nebulization gas to at least a selected one of the spray nozzles for a given time and an operation for ceasing the application of the high voltage to at least a selected one of the spray nozzles for the given time are carried out synchronously for the same selected spray nozzle.

In one feature of the present invention, the plural spray nozzles described above are two in number.

In another feature of the present invention, at least one of the spray nozzles described above is used for a standard substance.

Other objects and features of the invention will appear in the course of the description thereof, which follows.

### BRIEF DESCRIPTION OF THE DRAWING(S)

FIG. 1 is a diagram of a conventional electrospray ion source;

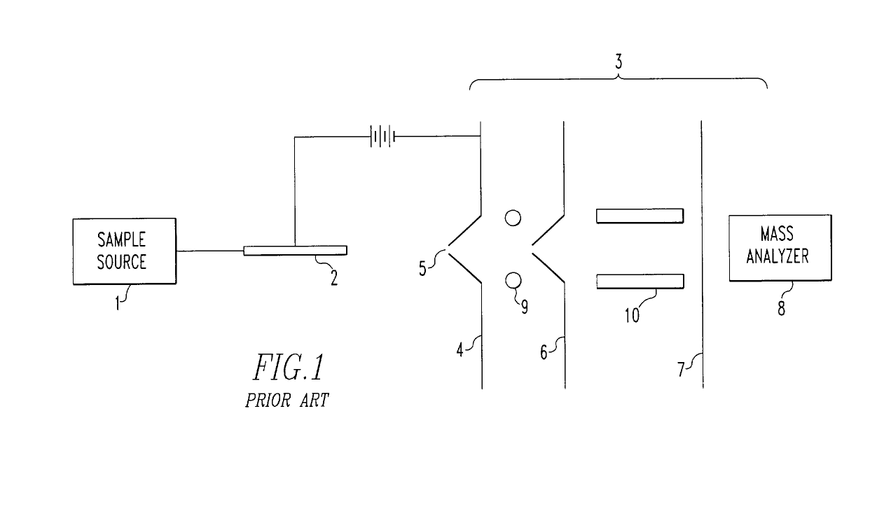

FIGS. 2(a), 2(b), and 2(c) are diagrams of another conventional electrospray ion source;

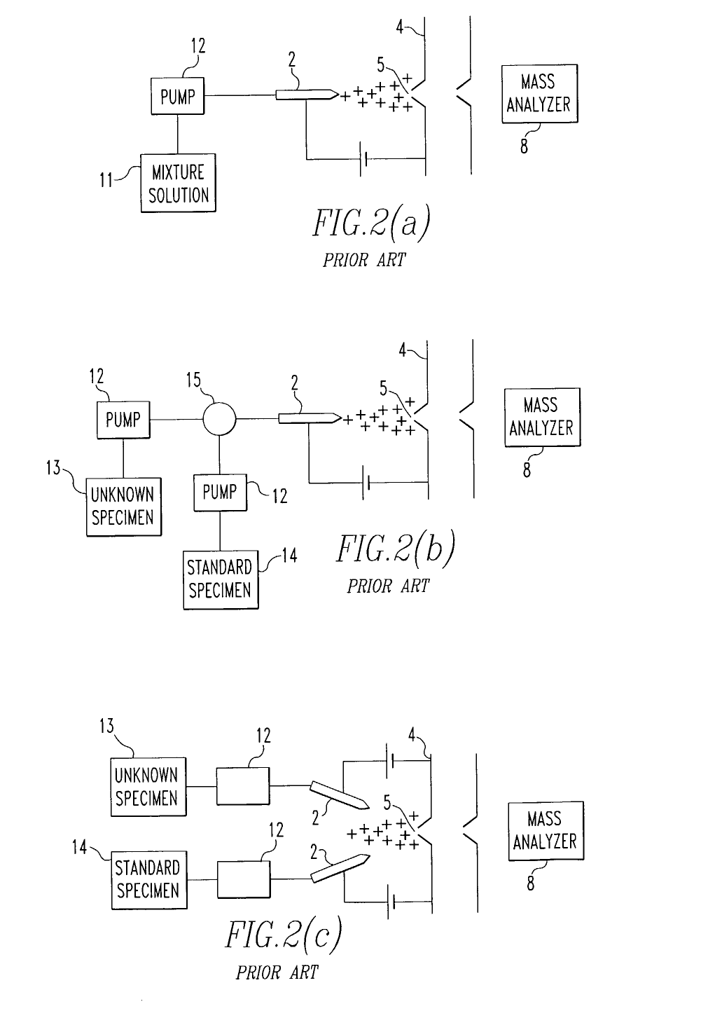

FIG. 3 is a diagram of an electrospray ion source in accordance with the present invention;

FIG. 4 is a time chart illustrating the operation of an electrospray ion source in accordance with the present invention; and

FIG. 5 is another time chart illustrating the operation of another electrospray ion source in accordance with the present invention.

### DESCRIPTION OF THE PREFERRED EMBODIMENT(S)

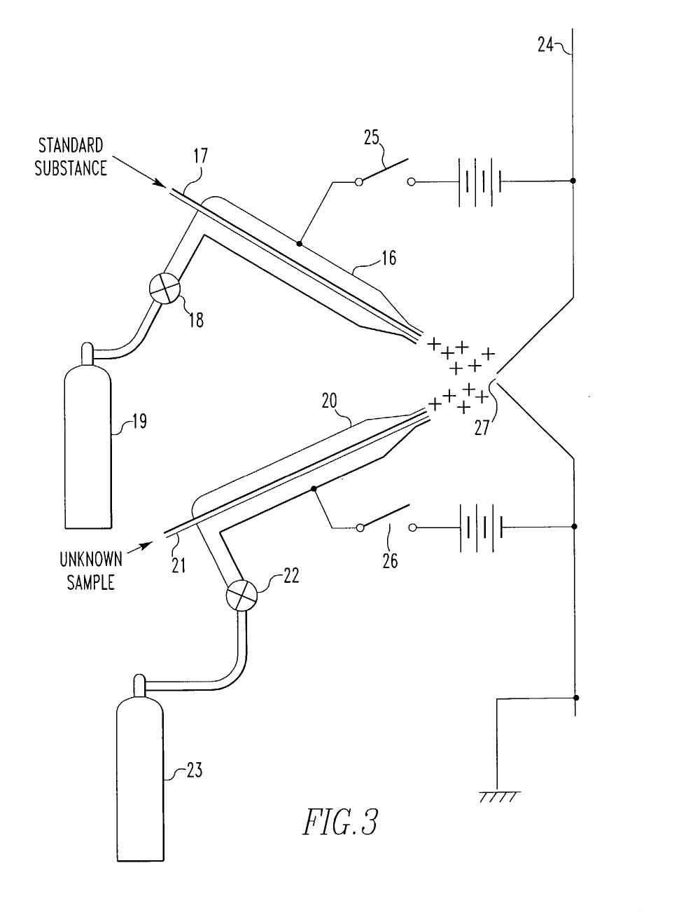

Referring to FIG. 3, there is shown an electrospray ion source embodying the concept of the present invention, the ion source being for use in a mass spectrometer. This ion source includes a spray nozzle 16 having a capillary 17 for passing a standard substance. A nebulization gas for assisting electrostatic spraying of the standard substance is supplied into the spray nozzle 16 from a gas source 19, such as a high-pressure nitrogen gas vessel via a valve 18. The ion source further includes another spray nozzle 20 having a capillary 21 for passing an unknown sample. The nebulization gas for assisting electrostatic spraying of the unknown sample is supplied to the spray nozzle 20 from a gas source 23, such as a high-pressure nitrogen gas vessel via a valve 22. The two valves 18 and 22 can be independently opened and closed under control of a control unit (not shown), such as a computer.

The mass spectrometer has a counter electrode 24 placed opposite to the two spray nozzles 16 and 20. A high voltage of several kilovolts is applied between the counter electrode 24 and each spray nozzle. The application of this high voltage can be turned on and off at will using switches 25 and 26.

Specifically, when the switch 25 is closed, the high voltage is applied between the spray nozzle 16 and the counter electrode 24, thus producing a high electric field between them. At this time, if the valve 18 is opened simultaneously with the closure of the switch 25 to place the gas source 19 in communication with the spray nozzle 16, the nebulization gas is supplied into the spray nozzle 16. The standard substance is electrostatically sprayed by the force of the electric field and the action of the nebulization gas. The generated fine droplets are ionized by the electric field and taken into a sampling orifice 27 formed in the counter electrode 24.

Similarly, if the switch 26 is closed, a high voltage is impressed between the spray nozzle 20 and the counter electrode 24, producing a strong electric field between them. At this time, if the valve 22 is opened synchronously with the closure of the switch 26 to place the gas source 23 in communication with the spray nozzle 20, the nebulization gas is supplied into the spray nozzle 20. The unknown sample is electrostatically sprayed by the force of the electric field and the action of the nebulization gas. The generated mist of droplets is ionized by the electric field and taken into the sampling orifice 27 formed in the counter electrode 24.

In the prior art accurate mass analysis, it is necessary that the standard substance and the unknown substance be simultaneously ionized and mass analyzed. Therefore, the switches 25 and 26 and the valves 18 and 22 are all simultaneously turned on or off. In the present invention, if necessary, only one of the switches 25 and 26 and the corresponding one of the valves 18 and 22 are arbitrarily turned on or off. Consequently, only the unknown sample can be ionized; in the past, both standard substance and unknown sample have been simultaneously ionized.

In the past, if a signal from the standard substance and a signal from the unknown sample are detected to overlap each other, there has not existed any means for discriminating them. In the present invention, either a signal arising from a standard substance or a signal arising from an unknown substance can be observed alone. Consequently, it is easy to discriminate the overlapping signals originating from the standard substance and the unknown sample, respectively.

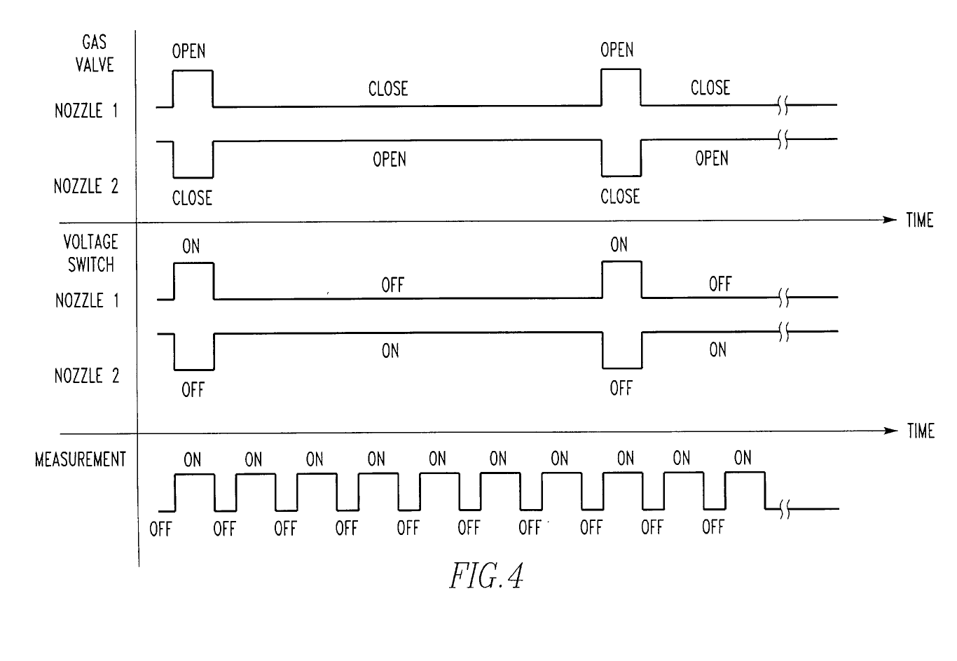

FIG. 4 is a time chart illustrating the relations between the times when the valves for the nebulization gas supplied to the first nozzle for spraying the standard substance and to the second nozzle for spraying the unknown sample are operated, the time when a high voltage is applied to the first nozzle for spraying the standard substance, the time when a high voltage is applied to the second nozzle for spraying the unknown sample, and times when measurements are made by the mass spectrometer.

The two top lines indicate the timing at which the gas valves for supplying the nebulization gas into the first and second nozzles, respectively, are opened and closed. As can be seen from the chart, the gas valve in communication with the second nozzle is closed while the gas valve connected with the first nozzle is being opened to spray the standard substance. Conversely, when the gas valve connected with the second nozzle is opened to spray the unknown substance, the gas valve connected with the first nozzle is closed. The period during which the gas valve connected with the second nozzle is opened is much longer than the period during which the gas valve connected with the first nozzle is opened, because the measurement time for the unknown sample is longer than the measurement time for the standard substance.

The two middle lines in the diagram indicate the timing at which the high-voltage switches for applying a high voltage to the first and second nozzles are turned on and off. As can be seen from the diagram, the switch for applying the high voltage to the second nozzle is kept off while the switch for applying the high voltage to the first nozzle to spray the standard substance is kept on. Conversely, when the switch for applying the high voltage to the first nozzle is kept on to spray the unknown sample, the switch for applying the high voltage to the first nozzle is kept off. The high voltage is applied to the second nozzle for a much longer time than to the first nozzle, because the unknown sample is measured for a longer time than the standard substance.

These operations for controlling the valves and switches for the first and second nozzles are alternately repeated synchronously. Consequently, only one of the standard substance and unknown sample can be nebulized at all times. Their simultaneous nebulization can be prevented.

Meanwhile, the mass spectrometer performs measurements repeatedly concerning sample ions generated from the nebulized sample droplets in synchronism with the nebulization of only one of the standard substance and unknown sample as shown at the bottom of the chart. In the illustrated example, one measurement is made regarding the standard substance, and then six consecutive measurements are made regarding the unknown sample. This sequence of measurements is taken as a cycle of measurements. Cycles of measurements are performed on the standard substance and the unknown sample. Consequently, a signal originating from the standard substance and a signal originating from the unknown sample can be separately observed because they do not overlap.

In the description of the above embodiment, two spray nozzles are used. The present invention is not limited to this scheme. Obviously, the procedures in accordance with the present invention are useful where more than two spray nozzles are used.

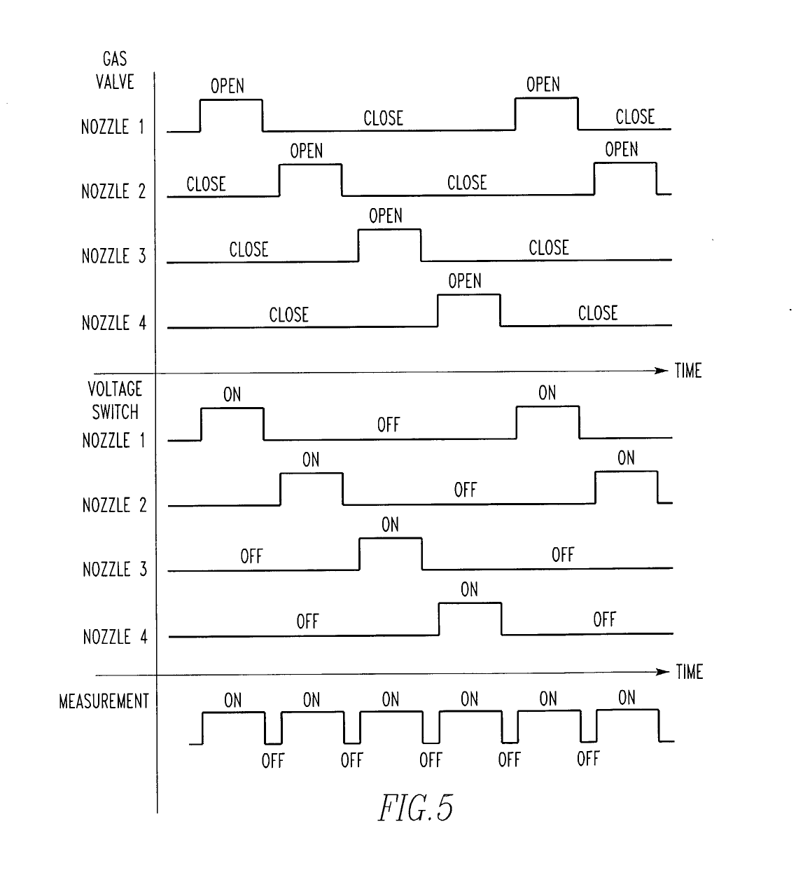

FIG. 5 is a time chart illustrating the timing at which gas valves and high-voltage switches are operated where four spray nozzles are used. It is assumed that different unknown samples are supplied to the four spray nozzles, respectively.

As a first stage, the gas valve for the first spray nozzle and the high-voltage switch operate synchronously to supply the nebulization gas and high voltage to the first spray nozzle for a given period. During this period, the gas valves for the other three spray nozzles and the high-voltage switches are all kept off. Since no nebulization gas is supplied and no high voltage is applied, only the unknown sample electrostatically sprayed from the first spray nozzle is analyzed by the mass spectrometer.

As a second stage, the gas valve for the second spray nozzle and the corresponding high-voltage switch operate synchronously to supply the nebulization gas and the high voltage to the second spray nozzle. During this period, the gas valves for the other three spray nozzles and the corresponding high-voltage switches are all kept off. No nebulization gas is supplied, and no high voltage is applied. In consequence, only the unknown sample electrostatically sprayed from the second spray nozzle is analyzed by the mass spectrometer.

As a third stage, the gas valve for the third spray nozzle and the high-voltage switch operate synchronously to supply the nebulization gas and the high voltage to the third spray nozzle. During this period, the gas valves for the other three spray nozzles and the corresponding high-voltage switches are all kept off. No nebulization gas is supplied, and no high voltage is applied. Only the unknown sample electrostatically sprayed from the third spray nozzle is analyzed by the mass spectrometer.

As a fourth stage, the gas valve for the fourth spray nozzle and the high-voltage switch operate synchronously to supply the nebulization gas and the high voltage to the fourth spray nozzle for a given period. During this period, the gas valves for the other three spray nozzles and the corresponding high-voltage switches are all kept off. No nebulization gas is supplied, and no high voltage is applied. Only the unknown sample electrostatically sprayed from the fourth spray nozzle is analyzed by the mass spectrometer.

These four stages are taken as one cycle of measurements. Cycles of measurements are performed on four unknown samples. Consequently, signals originating from the four unknown samples can be separately observed because they do not overlap.

Consequently, effluents from four independent liquid chromatographs can be analyzed at the same time by a single mass spectrometer. This enhances the efficiency of utilization of the mass spectrometer fourfold. This is especially advantageous where the mass spectrometer is capable of collecting a mass spectrum in a quite short time, such as a time-off-light mass spectrometer.

In this embodiment, all the samples supplied to the four nozzles, respectively, are taken as unknown samples. At least one of the four samples supplied into the nozzles may be replaced by a standard substance. In this case, only the time for which a measurement is performed regarding the standard substance can be set shorter as in the embodiment of FIG. 4.

In this example, accurate mass measurements of all the components eluting from three, for example, independent liquid chromatographs can be performed at the same time.

In the above-described embodiments, an electrospray ion source using spray nozzles each equipped with a nebulization gas supply system has been described. The invention is not limited to this structure. In an electrospray ion source using spray nozzles equipped with no nebulization gas supply system (e.g., nano-electrospray ion source), the inventive procedures consisting of selectively tuning off the high voltage applied to given spray nozzles are obviously advantageous in discriminating a signal arising from an unknown sample from a signal arising from a standard substance.

As described thus far, in the electrospray ion source in accordance with the present invention, a nebulization gas is supplied to plural spray nozzles. The supply of the nebulization gas to at least a selected one of the spray nozzles is cut off for a given time. The application of the high voltage to the spray nozzle for which the supply of the gas is cut off is synchronously ceased. Therefore, if signals from a standard substance and signals from an unknown sample overlap complexly in a complex system, they can be separately observed. Hence, the signals from the unknown substance can be easily discriminated from the signals arising from the standard substance. Further, the efficiency of utilization of the mass spectrometer can be enhanced greatly by analyzing plural unknown substances simultaneously.

Having thus described our invention with the detail and particularity required by the Patent Laws, what is desired protected by Letters Patent is set forth in the following claims.

The invention claimed is:

1. An electrospray ion source having plural spray nozzles which can be supplied with a nebulization gas and to which a high voltage can be applied, said spray nozzles being used substantially simultaneously,
wherein the supply of said nebulization gas to at least a selected one of said spray nozzles is cut off for a given time.

2. An electrospray ion source having plural spray nozzles to which a high voltage can be applied, said spray nozzles being used substantially simultaneously,
wherein the application of said high voltage to at least a selected one of said spray nozzles is ceased for a given time.

3. An electrospray ion source having plural spray nozzles which can be supplied with a nebulization gas and to which a high voltage can be applied, said spray nozzles being used substantially simultaneously,
wherein an operation for cutting off the supply of said nebulization gas to at least a selected one of said spray nozzles for a given time and an operation for ceasing the application of said high voltage to at least a selected one of said spray nozzles for a certain time are carried out synchronously for the same selected spray nozzle.

4. The electrospray ion source of claim 1, 2, or 3, wherein said plural spray nozzles are two in number.

5. The electrospray ion source of claim 1, 2, or 3, wherein at least one of said plural spray nozzles is a spray nozzle for a standard substance.
